(19) United States
(12) Patent Application Publication
(10) Pub. No.: US 2008/0163713 A1
(43) Pub. Date: Jul. 10, 2008

(54) SHIFTER WITH SPILL MANAGEMENT

(76) Inventor: Carl James Hessler, Rockford, MI (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/619,783

(22) Filed: Jan. 4, 2007

(51) Int. Cl. G05G 25/04; F16H 59/10

(52) U.S. Cl. 74/473.3; 74/538; 74/566

(57) ABSTRACT

A shifter assembly includes a cover having an opening, a base, and a shift lever extending from the base and through the opening and movable over a shift path. The shift lever is movable over a shift path and moves along the opening as the shift lever moves along the shift path. An absorbent member is located between the opening and the base. The absorbent member includes a material for absorbing liquid passing through the opening. The material for absorbing liquid is preferably sponge material.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to shifter assemblies for controlling transmissions of motor vehicles and, more particularly, to a shifter assembly having spill management for protection of the shifter assembly when drinks or other liquids are spilled onto the shifter assembly.

### BACKGROUND OF THE INVENTION

In a vehicle equipped with an automatic transmission, a shift lever is typically pivotable over a series of positions representative of transmission gears such as, for example, park (P), reverse (R), neutral (N), drive (D), and low gears (2, 1). The shift lever is operably connected to the motor vehicle transmission by a suitable mechanical and/or electronic operating linkage to effect actuation of the transmission to the selected gear when the shift lever is pivoted to the transmission gear's representative position. The shift lever is typically provided with a knob assembly having a detent member which releasably holds the shift lever in its current position to prevent inadvertent movement of the shift lever. The knob assembly typically includes a manually operable button which permits the operator to release the detent member and move the shift lever.

The shift lever also typically provided with a locking mechanism which locks the shift lever in a predetermined gear position against movement to other gear positions when predetermined conditions are present. The lock mechanism thus disables the knob assembly so that the operator cannot move the shift lever under certain predetermined conditions. Typically, the lock mechanism prevents movement of the shift lever out of the park position unless a brake foot pedal is depressed and/or other desired conditions are present to reduce the likelihood of unattended or unintended movement or acceleration of the vehicle. These locking mechanisms typically have electrically actuated devices such as solenoids which block movement of the detent member unless the predetermined conditions are met.

The shift lever is often located at a bottom center of the instrument panel on a center console generally between the driver seat and the front passenger seat. Cup holders are also often located on the center console or just above the center console. These cup holders are used for holding coffee cups, water bottles, soft drink cans and bottles, and the like. Thus, the center console can be susceptible to spills of various liquids. The spilled liquids can flow into the shifter lever and damage various electric components such as solenoids, switches and the like.

U.S. Pat. Nos. 5,680,799 and 6,182,530, the disclosures of which are expressly incorporated herein in their entireties by reference, disclose funnel like components which are formed to route spills away from sensitive areas of the shifter assemblies. While these funnel components may be somewhat effective at preventing damage to shifter assemblies due to liquid spills, they are relatively expensive to produce and may not be very effective for large sudden spills.

There is a desire to reduce damage to shifter assemblies due to liquid spills. Also, there is a never ending desire in the motor vehicle industry to reduce size, weight, and cost while retaining and/or obtaining desirable characteristics. Accordingly, there is a need in the art for an improved shift assembly with spill management.

### SUMMARY OF THE INVENTION

The present invention provides a shifter assembly which addresses one or more problems of the related art. According to the present invention, a shifter assembly comprises, in combination, a cover having an opening, a base, and a shift lever extending from the base and through the opening and movable over a shift path. The shift lever is movable over a shift path and moves along the opening as the shift lever moves along the shift path. An absorbent member is located between the opening and the base. The absorbent member includes a material for absorbing liquid passing through the opening.

According to another aspect of the present invention, a shifter assembly comprises, in combination, a shift lever movable over a shift path and an absorbent member secured to the shift lever and movable with the shift lever as the shift lever moves over the shift path. The absorbent member includes a material for absorbing liquid.

According to yet another aspect of the present invention, an automatic transmission shifter assembly comprises, in combination, a cover having an opening, a shift lever extending through the opening and movable over a shift path, and a slider located below the cover and substantially closing the opening of the cover. The shift lever moves along the opening as the shift lever moves along the shift-path. The slider has an opening for passage of the shift lever therethrough. An absorbent member has an opening for passage of the shift lever therethrough and moves with the shift lever as the shift lever moves along the shift path. The absorbent member includes a material for absorbing liquid passing through the opening of the slider.

From the foregoing disclosure and the following more detailed description of various preferred embodiments it will be apparent to those skilled in the art that the present invention provides a significant advance in the technology and art of motor vehicle shifter assemblies. Particularly significant in this regard is the potential the invention affords for providing a high quality, reliable, low cost assembly with spill management. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a plan top view of motor vehicle center console having a shifter assembly spill management according to the present invention;

FIG. 2 is an enlarged, fragmented side elevational view, partially in cross-section, showing the shifter assembly of FIG. 1;

FIG. 3 is an enlarged plan top view of an absorber member of the shifter assembly of FIGS. 1 and 2;

FIG. 4 is a side elevational view of the absorber member of FIG. 3; and

FIG. 5 is an end elevational view of the absorber member of FIGS. 3 and 4.

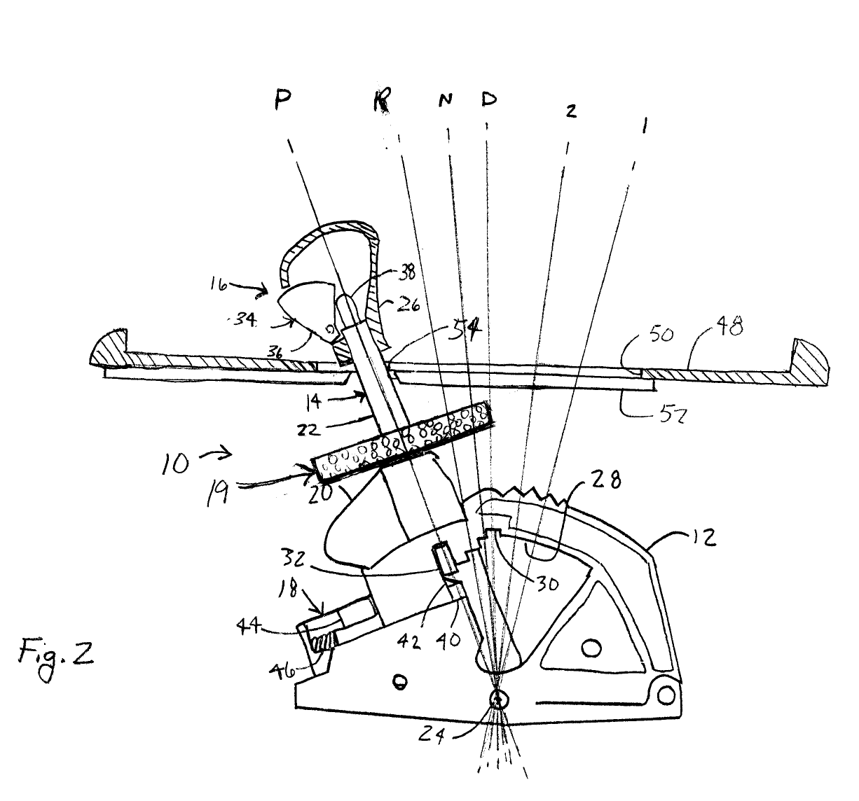

It should be understood that the appended drawings are not necessarily to scale, presenting a somewhat simplified representation of various preferred features illustrative of the basic principles of the invention. The specific design features of a shifter assembly as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter assembly illustrated in the drawings. In general, up or upward generally refers to an upward direction within the plane of the paper in FIG. 2 and down or downward generally refers to a downward direction within the plane of the paper in FIG. 2. Also in general, fore or forward refers to a direction toward the front of the vehicle, that is, generally toward the left within the plane of the paper in FIG. 2 and aft or rearward refers to a direction toward the rear of the vehicle, that is, generally toward the right within the plane of the paper in FIG. 2.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved shifter assembly disclosed herein. The following detailed discussion of various alternative and preferred embodiments will illustrate the general principles of the invention with reference to an automatic transmission shifter assembly for a motor vehicle such as, for example, an automobile, truck, van, cross over vehicle, sport utility vehicle (SUV), recreational vehicle, trailer, off road vehicle such as a dune buggy, industrial or construction equipment, golf cart, or the like. Other embodiments suitable for other applications of the invention will be apparent to those skilled in the art given the benefit of this disclosure such as, for example, a standard-shift transmission shifter assembly for a motor vehicle.

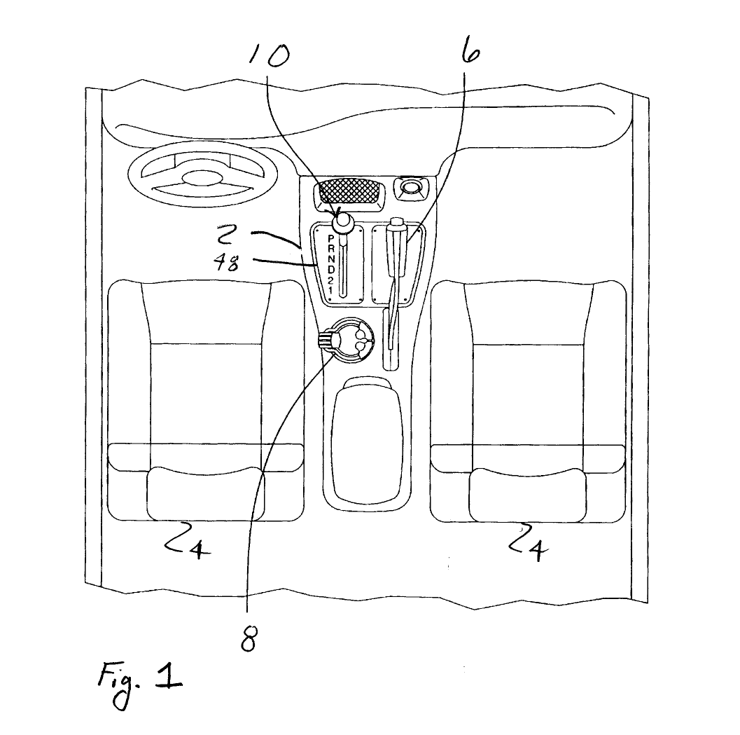

Referring now to the drawings, FIG. 1 shows a shifter assembly 10 according to a preferred embodiment of the present invention located on a center console 2 of a motor vehicle generally between driver and front passenger seats 4. Also located at the center console 2 are a parking-brake hand lever 6 and a cup holder 8. The cup holder 8 is sized and shaped for holding coffee cups, water bottles, soft drink cans and bottles, and the like.

As best shown in FIG. 2, the illustrated shifter assembly 10 includes a frame or base 12, a shift lever assembly 14 movable relative to the base 12 over a shift path defining a plurality of gear positions, a knob assembly 16 releasably holding the shift lever assembly 14 in a desired one of a plurality of gear positions against undesired and/or inadvertent movement to the other gear positions, a locking mechanism 18 for locking the shift lever assembly 14 in a predetermined one of the gear positions against movement to the other gear positions when predetermined conditions are present, and an absorber member 19 for absorbing liquids spilled at the shifter assembly 10 to prevent the liquids from damaging sensitive components such as, for example, the locking mechanism 18.

The illustrated base 12 is adapted to be attached to the motor vehicle in a fixed position such as the vehicle floor, center console 2, or other suitable structure. The base 12 is shaped to engage the motor vehicle in a desired manner and is typically provided with openings or holes for receiving mechanical fasteners such as bolts to secure the base to the motor vehicle.

The illustrated shift lever assembly 14 includes a pivot member or yoke 20, a shift lever or post 22 for manually moving the pivot member 20. The lower end of the pivot member 20 is sized and shaped to extend between pivot flanges of the base 12 and cooperate with the base 12 to provide a pivotable connection between the pivot member and the base 12. Pivotably connected in this manner, the pivot member 20 is pivotable about a horizontal and laterally extending pivot axis 24 so that shift lever assembly 14 moves over a generally straight shift path extending in the forward-rearward direction. It is noted however, that the shift path can alternatively have any other suitable shape and/or direction such as, for example, the shift path could alternatively include laterally extending portions.

The illustrated shift lever 22 is generally an elongate tube having a hollow central passage. The lower end of the shift lever 22 is adapted to be secured to the pivot member 20. With the shift lever 22 secured to the pivot member 20, the pivot member 20 can be pivoted about the pivot axis 24 by manually applying a force to the shift lever 22. The upper end of the illustrated shift lever 22 is provided with handle or knob 26. The knob 26 is preferably provided with a shape to provide a suitable gripping surface for the hand of the operator.

The illustrated base 12 has a detent plate or gate 28 having a curvature about the pivot axis 24. The illustrated gate 28 has a lower contoured surface with a plurality of downward facing grooves or notches 30 formed therein. The notches 30 define the various gear positions along the shift path which the shift lever assembly 14 can be moved to provide a desired gear at the transmission of the motor vehicle. The illustrated notches 30 define the gear positions of park (P), reverse (R), neutral (N), drive (D), second low gear (2), and first low gear (1). It is noted, however, that the notches 30 can alternatively define any other suitable plurality of gear positions. The shift lever assembly 14 is operably connected to the transmission of the motor vehicle via mechanical and/or electrical linkages such that movement the shift lever assembly 14 to the various gear positions along the shift path causes the transmission to move to the corresponding gear. The notches 30 are sized and shaped to cooperate with the knob assembly 16 to limit movement of the shift lever assembly 14 as discussed in more detail hereinbelow. The illustrated notches 30 are each rectangular shaped and are sized differently in order to control movement of the shift lever assembly 14 in a desired manner. It is noted that the notches 30 can alternatively have other suitable shapes such as, for example, arcuate and/or can each be sized the same.

The illustrated knob assembly 16 includes the knob 26, a detent member or gate pin 32 movable into and out of engagement with the notches 30, and an actuator 34 for selectively moving the detent member 32. The illustrated knob assembly 16 is secured to the shift lever assembly 14 for movement therewith but alternatively the gate 28 and the gate pin 32 can be reversed. The pivot member 20 forms a guide opening or passage for the detent member 32 so that the detent member 32 is linearly moved by the actuator 34 along a linear path extending toward and away from the notches 30, that is, in a direction substantially perpendicular to the notches 30. The illustrated detent member 32 moves along the central axis of the shift lever assembly 14 and intersects the pivot axis 24. The detent member 32 is sized and shaped to closely cooperate with the guide opening so that the guide opening guides the detent member 32 to maintain movement of the detent member 32 along the linear path. The detent member 32 is also sized and shaped to cooperate with the notches 30 of the gate 28 so that the detent member 32 blocks and limits pivotal movement of the shift lever assembly 14 when the detent member 32 is in one of the notches 30 but permits pivotal movement of the shift lever assembly 14 when the detent member 32 is removed from the notch 30. The engagement portion of the illustrated detent member 32 is generally rectangular to cooperate with the rectangular-shaped notches 30 but any other suitable shape can alternatively be utilized.

The illustrated actuator 34 includes a manually operated button member 36 and a connecting member or rod 38 extending from the button member 36 to the detent member 32. The illustrated button member 36 is pivotably secured to the knob 26 and is provided with an engagement surface sized and shaped for interacting with the connecting rod 38. The illustrated connecting rod 38 extends within the interior passage of the shift lever 22 and is linearly movable along the central axis of the shift lever 22. The lower end of the connecting rod 38 is secured to the detent member 32. The upper end of the connecting rod 38 is sized and shaped to interact with the button member 36 so that manual actuation of the button member 36 in a direction into the knob 26 linearly and downwardly moves the connecting rod 38 and the detent member 32 connected thereto toward the pivot axis 24 and away from the notches 30. A spring member is preferably provided within the shift lever 22 to resiliently bias the connecting rod 38 in an upward direction so that the detent member 32 is resiliently biased toward the notches 30. It is noted that the actuator 34 can alternatively be of any other suitable type such as, for example, an electric linear actuator with a control switch.

The illustrated locking mechanism 18 is positioned at a forward end of the base 12 adjacent the notch 30 defining the park gear position so that the locking mechanism 18 prevents movement of the shift lever assembly 14 out of the park gear position unless a foot brake pedal is depressed and an ignition key is present or activated to reduce the likelihood of unattended or unintended movement or acceleration of the motor vehicle. It is noted that the locking mechanism 18 can alternatively be utilized to secure the shift lever assembly 14 in any other gear position. It is also noted that the locking mechanism 18 can be operated upon the presence of any other suitable predetermined conditions.

The illustrated locking mechanism 18 includes a stopper member 40 movable between a locking position wherein the stopper member 40 is within the path of the detent member 32 to block movement of the detent member along at least a portion of the path and prevent removal of the detent member 32 from the notch 30 and an unlocking position wherein stopper member 40 is positioned to permit the detent member 32 to move along the path out of the notch 30. The illustrated locking member also includes a control or cam member 42 selectively applying a force to the stopper member 40 to move the stopper member 40 toward its unlocking position when activated, an electric solenoid 44 for selectively locking the stopper member 40 and the control member 42 together so that movement of the control member 42 moves the stopper member 40 to its unlocking position, and a spring member 46 resiliently biasing the stopper member 40 toward its locking position.

The illustrated stopper member 40 is movable along a horizontal linear path between the locking or blocking position wherein the stopper member 40 is within a portion of the linear path of the detent member 32 to block movement of the detent member out of the notch 30 defining the park gear position and an unlocking or unblocking position wherein stopper member 40 is positioned so that it does not block the linear path of the detent member 32 to permit the detent member 32 to move along the linear path out of the notch 30 defining the park gear position. The illustrated spring member 46 engages a forward end of the stopper member 40 to resiliently bias or urge the stopper member 40 in a rearward direction toward its locking position.

When the shift lever assembly 14 is in the park position P, the spring member 46 biases the stopper member 40 to its locking position within the path of the detent member 32. If the predetermined conditions are not met (for example, the foot brake pedal is not depressed and the key is not in or operating the ignition), the electric solenoid 44 is unenergized so that the control member 42 is not locked to the stopper member 40. If the operator actuates the knob assembly 16 to move the shift lever assembly 14 while the electric solenoid is unenergized, the detent member 32 moves the control member 42 out of its path and the detent member 32 engages the stopper member 40. The engagement with the stopper member 40 prevents further downward movement of the detent member 32 along its linear path so that the detent member 32 cannot be removed from the park gear notch 30. Thus, the operator cannot remove the shift lever assembly 14 from the park gear position. If the predetermined conditions are met (for example, the foot brake pedal is depressed and the key is in or operating the ignition), the electric solenoid 44 is energized so that the control member 42 is locked to the stopper member 40. If the operator actuates the knob assembly 16 to move the shift lever assembly 14 while the electric solenoid 44 is energized, the detent member 32 moves the control member 42 as well as the stopper member 40 locked thereto out of its path so that the detent member 32 can move along its linear path and is removed from the park gear notch 30. With the detent member 32 out of the park gear notch 30, the operator can move the shift lever assembly 14 from the park gear position to another desired gear position. It is noted that the locking mechanism 18 can alternatively be of any other suitable type.

Located at the center console 2 is a position-indicator panel or housing cover 48 having an elongate slot-like aperture 50 for passage of the shift lever 22 therethrough. The shift lever 22 moves along the aperture 50 as the shift lever 22 moves over its shift path. The top of the housing cover 48 is provided with the characters “P”, “R”, “N”, “4D”, “2”, and “1” along the aperture 50 to indicate the current gear position of the shift lever 22. A slide sheet or slider 52 is provided beneath the housing cover 48 and has an opening 54 through which the shift lever 22 passes. The slider 52 is arranged to cover the elongate aperture 50 and slide with the shift lever 22 as the shift lever 22 moves over its shift path to allow the aperture 50 to always be closed so as to conceal internal components of the shifter assembly 10 from outside the center console 2.

The illustrated spill management system includes the absorber member 19 which is located along the shift lever 22 between the slider 52 and the yoke 20. In this position, the absorber member 19 absorbs liquid which may pass through the aperture 50 along the shift lever 22 to prevent the liquid from reaching sensitive mechanical and electrical components, such as the electric solenoid 44, which can be damaged by the liquid. Liquid in the absorber member 19 can harmlessly evaporate over time and may drip in harmless quantities to evaporate from other locations. Located on the shift lever 22, the absorber member 19 moves with the shift lever 22 to remain located below the slider opening 54 regardless of the location of the shift lever 22 along its shift path.

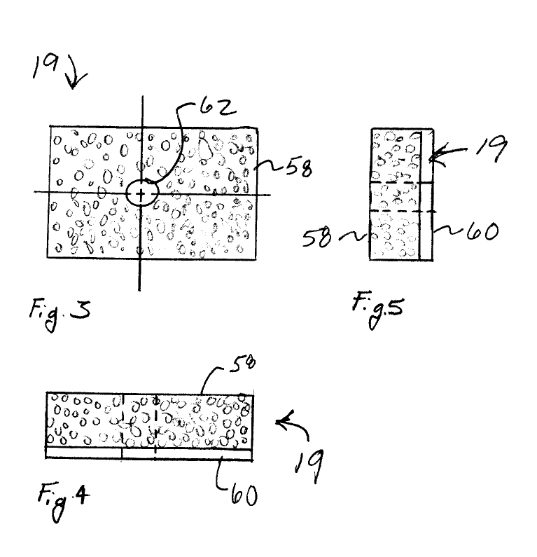

As best shown in FIGS. 3 to 5, the illustrated absorber member 19 includes a layer of absorbent material 58 suitable for absorbing liquid such as, for example, sponge, foam, cloth, paper, or the like. The illustrated absorber member 19 also includes a layer of carrier material 60 suitable for supporting the absorbent material 58 and positioning the absorber member 19 along the shift lever 22 in a desired position. The carrier material 60 can be any suitable material and can be secured to the absorbent material 58 in any suitable manner such as with adhesive or the like. It is noted that the carrier material 60 can be eliminated if desired.

The illustrated absorber member 19 is rectangular shaped having a length of about 50 mm, a width of about 30 mm, and a thickness of about 15 mm. It is noted, however, that the absorber member 19 can alternatively have any other suitable shapes and sizes depending on the size and shape of the openings through which the liquid can pass and the location of the sensitive components of the shifter assembly 10. The illustrated absorber member 19 has an opening 62 sized and shaped for closely receiving the shift lever 22 therein for positioning the absorber member 19 in a desired position along the shift lever 22.

If a soft drink, coffee, water or other liquid is spilled on the center console 2, any liquid passing through the housing cover aperture 50 and the slider opening 54 impacts the absorber member 1 9 and is absorbed by the absorbent material 58. Thus, the liquid is prevented from reaching sensitive mechanical and electrical components, such as the electric solenoid 44, which can be damaged by the liquid. The absorbent material 58 harmlessly dries over time. The absorber member 19 can be sized and shaped to absorb large quantities of liquid.

From the foregoing disclosure and detailed description of certain preferred embodiments, it is apparent that the present invention provides a device that effectively protects sensitive components from damage due to liquid spills. It is also apparent that the present provides spill containment that is relatively inexpensive compared to prior art devices.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shifter assembly comprising, in combination:
a cover having an opening;
a base;
a shift lever extending from the base and through the opening and movable over a shift path;
wherein the shift lever is movable over a shift path and moves along the opening as the shift lever moves along the shift path;
an absorbent member located between the opening and the base; and
wherein the absorbent member includes a material for absorbing liquid passing through the opening.

2. The shifter assembly according to claim 1, wherein said absorbent material comprises sponge.

3. The shifter assembly according to claim 1, wherein said absorbent member includes a carrier layer for supporting the material for absorbing material.

4. The shifter assembly according to claim 1, wherein said absorber member is rectangular shaped.

5. The shifter assembly according to claim 1, wherein the absorber member has an opening for passage of the shift lever therethrough.

6. The shifter assembly according to claim 1, wherein the absorber member is secured to the shift lever and moves with the shift lever as the shift lever moves along the shift path.

7. The shifter assembly according to claim 1, wherein the shifter assembly is an automatic transmission shifter assembly.

8. The shifter assembly according to claim 1, further comprising electric components secured to the base.

9. The shifter assembly according to claim 1, further comprising a slider having an opening for passage of the shift lever and located below the cover and substantially closing the opening of the cover.

10. A shifter assembly comprising, in combination:
a shift lever movable over a shift path;
an absorbent member secured to the shift lever and movable with the shift lever as the shift lever moves over the shift path; and
wherein the absorbent member includes a material for absorbing liquid.

11. The shifter assembly according to claim 10, wherein said absorbent material comprises sponge.

12. The shifter assembly according to claim 10, wherein said absorbent member includes a carrier layer for supporting the material for absorbing material.

13. The shifter assembly according to claim 10, wherein said absorber member is rectangular shaped.

14. The shifter assembly according to claim 10, wherein the absorber member has an opening for passage of the shift lever therethrough.

15. The shifter assembly according to claim 10, wherein the shifter assembly is an automatic transmission shifter assembly.

16. The shifter assembly according to claim 10, further comprising electric components damageable by liquid.

17. The shifter assembly according to claim 10, further comprising a cover having an opening, wherein the shift lever moves along the opening as the shift lever moves along the shift path, and wherein the absorbent member absorbs liquid passing through the opening.

18. The shifter assembly according to claim 17, further comprising a slider having an opening for passage of the shift lever and located below the cover and substantially closing the opening of the cover.

19. An automatic transmission shifter assembly comprising, in combination:
a cover having an opening;
a shift lever extending through the opening and movable over a shift path;
wherein the shift lever moves along the opening as the shift lever moves along the shift path;
a slider located below the cover and substantially closing the opening of the cover;
wherein the slider has an opening for passage of the shift lever therethrough;
an absorbent member having an opening for passage of the shift lever therethrough and moving with the shift lever as the shift lever moves along the shift path; and
wherein the absorbent member includes a material for absorbing liquid passing through the opening of the slider.

20. The shifter assembly according to claim 19, wherein said absorbent material comprises sponge.
